(19) United States
(12) Patent Application Publication
(10) Pub. No.: US 2008/0156110 A1
(43) Pub. Date: Jul. 3, 2008

(54) Method for fixing an attachment part on the measurement tube of a coriolis mass flowmeter and coriolis mass flowmeter

(75) Inventors: Lothar Deppe, Gottingen (DE); Reinhard Steinberg, Worbis (DE); Frank Kassubek, Rheinfelden (DE); Wolfgang Waldi, Nussloch-Maisbach (DE); Jorg Gebhardt, Mainz (DE); Rene Friedrichs, Rosdorf (DE); Steffen Keller, Konstanz (DE)

Correspondence Address: BUCHANAN, INGERSOLL & ROONEY PC, POST OFFICE BOX 1404, ALEXANDRIA, VA, 22313-1404, US

(73) Assignee: ABB Patent GmbH, Ladenburg (DE)

(21) Appl. No.: 12/000,031

(22) Filed: Dec. 7, 2007

(30) Foreign Application Priority Data
Dec. 7, 2006 (DE) 10 2006 057 707.8
Dec. 5, 2007 (DE) 10 2007 058 359.3

(51) Int. Cl. G01F 1/84; B23K 1/008

(52) U.S. Cl. 73/861.357; 228/101

(57) ABSTRACT

The disclosure relates to a method for fixing an attachment part on the measurement tube of a Coriolis mass flowmeter at at least two connection points. According to the disclosure, the measurement tube and the attachment part are soldered to one another in a single hard-soldering process at the same time at the at least two connection points.

### RELATED APPLICATIONS

This application claims priority under 35 U.S.C. §119 to German Application 10 2006 057 707.8 filed in Germany on Dec. 07, 2006; and to German Application 10 2007 ______ filed in Germany on Dec. 03, 2007, the entire contents of which are hereby incorporated by reference in their entireties.

### TECHNICAL FIELD

The disclosure relates to a method for fixing an attachment part on the measurement tube of a Coriolis mass flowmeter at at least two connection points, and to a Coriolis mass flowmeter with a measurement tube and an attachment part, which is connected thereto at at least two connection points.

### BACKGROUND INFORMATION

Coriolis mass flowmeters with a straight measurement tube often comprise structures running parallel to the measurement tube, such as attachment parts, frames, housings etc., for example, which are connected to one another and/or to the measurement tube at opposite ends. Since, in the case of Coriolis mass flowmeters, deflections of the measurement tube during the measurement or during a throughflow which is different from zero, a particularly high requirement as regards stability but also as regards fixing-in of the measurement tube with little dissipation of energy needs to be placed on the fixing technique of the measurement tube and of the attachment parts on the measurement tube.

Various fixing and connection techniques for fixing attachment parts on the measurement tube of a Coriolis mass flowmeter are known.

A relatively simple connection technology is that of a hard-soldering joint. However, mechanical stresses can also be produced locally or in further extended ranges as a result of a hard-soldering joint, which is produced along a line of contact and can thus be frozen in as a result of the process or after cooling of the connection points. This has a disadvantageous effect on the ultimate measuring device.

### SUMMARY

The disclosure is based on the object of specifying a method with which an attachment part can be fixed on the measurement tube of a Coriolis mass flowmeter at at least two connection points substantially without any stress.

As disclosed, the measurement tube and the attachment part are soldered to one another in a single hard-soldering process at the same time as the at least two connection points. As a result, high-quality and stress-free soldered joints can be produced at the same time at all the connection points. No stresses are built up between the various connection points during the hard-soldering process. Since all the connection points are heated uniformly and run through the same temperature profile, which brings about the various phase formations in the hard-solder joints to be produced at the various connection points.

### BRIEF DESCRIPTION OF THE DRAWINGS

The disclosure and further exemplary configurations and improvements of the disclosure will be explained in more detail and described with reference to the drawings, in which three exemplary embodiments of the invention are illustrated and in which:

FIG. 1 shows an exemplary temperature profile, as is used in the method in accordance with the disclosure,

FIG. 2 shows a schematic arrangement of the measurement tube and the attachment part of a Coriolis mass flowmeter,

FIG. 3 shows a schematic arrangement of a further exemplary embodiment of a Coriolis mass flowmeter, which is manufactured in accordance with the method according to the disclosure, and

FIG. 4 shows a schematic arrangement of a third exemplary embodiment of a Coriolis mass flowmeter, which is manufactured in accordance with the method according to the disclosure.

### DETAILED DESCRIPTION

First, FIG. 2 will be taken into consideration. FIG. 2 shows, schematically, a measurement tube 2, on which a U-shaped attachment part 4 is connected to the measurement tube at two fixing points 6, 7 close to the two end points 9, 11 of said measurement tube.

The joints at the fixing points 6, 7 are surface joints. The attachment part 4 extends parallel to the measurement tube 2. Care therefore needs to be taken to ensure that the fixing process does not introduce any undesirable axial stresses into the system comprising the measurement tube 2 and the attachment part 4.

The attachment part 4 may also be a U-shaped frame, the measurement tube 2 needs to be connected thereto at the two end points. This frame can in this case also be the housing of the meter. Here, the method for producing the connection needs to ensure that the clamping-in of the measurement tube within the attachment part or the housing part takes place without any stresses, which ultimately results in a high-quality measurement tube corresponding to the requirements for a Coriolis mass flowmeter.

In order to achieve the required high-quality joint whilst avoiding axial stress, the joints are produced at all fixing points in a single hard-soldering process together and at the same time.

For this purpose, the entire arrangement of parts to be soldered is heated in a corresponding furnace surrounding them and during the heating a temperature curve is run through in only a single cohesive temperature-regulated process. In this case, the temperature curve profile, i.e. the stepwise heating and possible maintenance of specific temperature plateaus, is run through continuously in a single, i.e. uninterrupted temperature-regulated process.

This has the advantage that no stresses are built up during the hard-soldering process. All parts which are intended to be connected to one another are heated uniformly and run through a temperature profile, which brings about the various phase formations in the hard-solder joint to be produced. The hard-solder substances are introduced in advance at the connection points.

In order to produce a good hard-soldered joint, it is in this case important to bring the parts together and possibly to hold or fix them so that a very small solder gap is produced which has a constant width, which is very small, for example <0.1 mm. The solder material can, for example, be introduced into the solder gap in the form of a ring, possibly together with a film promoting the coverage of the surfaces to be connected. This naturally induces the requirement for exact fabrication parameters in the production of the parts.

The parts to be connected are held together in their desired position via a corresponding apparatus, even before the entire arrangement of the parts to be connected is introduced into the furnace, and also during the soldering process itself. The holding apparatus is advantageously made from the same materials as the measurement tube in order that the coefficients of thermal expansion are made the same. Once the soldering process has been terminated, the holding apparatus is again removed since it is then no longer required.

An alternative fixing possibility is fixing by means of individual weld points, in which case great care needs to be taken and the weld points need to be positioned symmetrically with respect to the measurement tube in order to avoid mechanical stresses as a result of the welding.

It is also conceivable for the attachment part to be clamped on by means of a corresponding shaping, for example by the attachment part being provided with drilled holes in the region of the fixing points and the attachment part being pushed with these drilled holes over the measurement tube so that it is held there by a press fit.

The temperature/time profile of the soldering process needs to be regulated very effectively. The parts to be connected, the measurement tube 2 and the attachment part 4 running parallel to the measurement tube 2, have a different surface-to-volume ratio, as a result of which different thermal expansions and expansion rates in relation to the thermal radiation within the furnace result. It is important to prevent this since otherwise axial stresses are produced which can lead to plastic deformation. In addition, axial stresses have a negative influence on the oscillation response of the measurement tube, as has already been mentioned.

For this reason, the temperature ramps need to be approached slowly in order to take into consideration these different thermal expansions.

In an exemplary embodiment, in this case the measurement tube and the attachment parts are made from the same material, for example from titanium or from stainless steel. This has the advantage that there are no material-specific differences in the thermal expansion response.

In a further exemplary embodiment, materials are selected for the measurement tube and the attachment part whose coefficients of thermal expansion are similar at least until the soldering temperature is reached, so that, as a result, material-specific differences in the thermal expansion response are minimized.

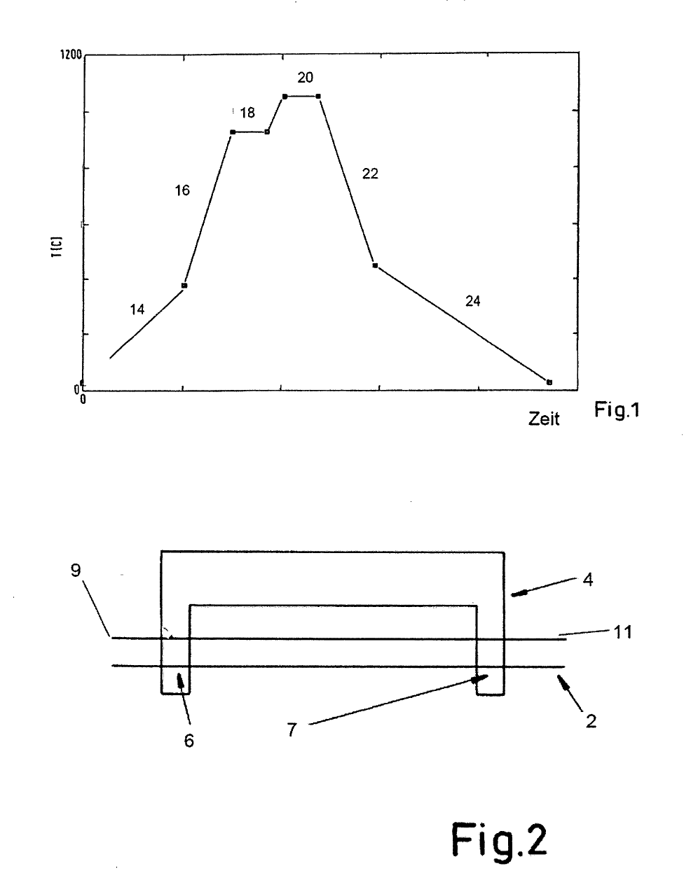

FIG. 1 shows, schematically, a typical temperature/time profile, as can be used in the method according to the disclosure.

In a first section 14, there is slow heating, followed by a zone 16 with a steeper gradient up to a first plateau 18 of the temperature. After a short residence time at the first plateau 18, a second plateau 20, which is slightly above the first plateau and is likewise held for a short time is reached. There then follows a controlled, relatively rapid cooling ramp 22, followed by a zone 24 with slower cooling to room temperature. The gradients in the individual zones, the maintenance points, and also the points with different temperature gradients are to be determined for each material combination by means of standard tests. The implementation and evaluation of such tests is known to a person skilled in the art. However, it is critical here to realize the conclusive process of heating up to cooling.

The hard-soldering at all fixing points can in this case be realized in this single method process. That is to say in this case different hard-soldering steps no longer need to be carried out, but the hard-soldered joints can be produced in a single thermal process.

In an exemplary embodiment, the attachment part itself can also comprise a plurality of attachment sub-parts. These are then likewise connected to one another by means of hard-soldered joints, to be precise in the same soldering process in which the attachment part is soldered on the measurement tube. To a certain extent the attachment part is therefore first assembled to form an integral attachment part during the soldering process used to connect the attachment part to the measurement tube. The individual attachment sub-parts themselves are in this case fixed in the required mutual position in relation to one another before the beginning of the soldering process, it being possible to use the same means and methods as have already been described above in relation to the mutual fixing of a plurality of attachment parts on the measurement tube.

Both the production method of a Coriolis mass flowmeter, which comprises a plurality of fixing points at which an attachment part or else a plurality of attachment parts are fixed on the measurement tube by means of in total a plurality of hard-solder joints, is simplified and the required freedom from stress of the hard-solder joints and the avoidance of axial stresses between the measurement tube 2 and the attachment part 4, which extends parallel to the measurement tube, is achieved.

The hard-soldered joints produced in this way are largely free from defects and free from inclusions or cavities in the region of the fixing points. Furthermore, they also have long term stability when loaded with the vibrations occurring during operation of the mass flowmeter, i.e. their properties do not change over time. The hard-solder joints produced in this way also do not degrade at relatively high operating temperatures, which may be up to 150° C. or even higher.

The hard-solder joints produced in accordance with the disclosure transmit transverse forces, which can be exerted by the attachment part on the measurement tube, and likewise torques, which result from torsional movement of the attachment part, and axial forces as a result of thermal expansions.

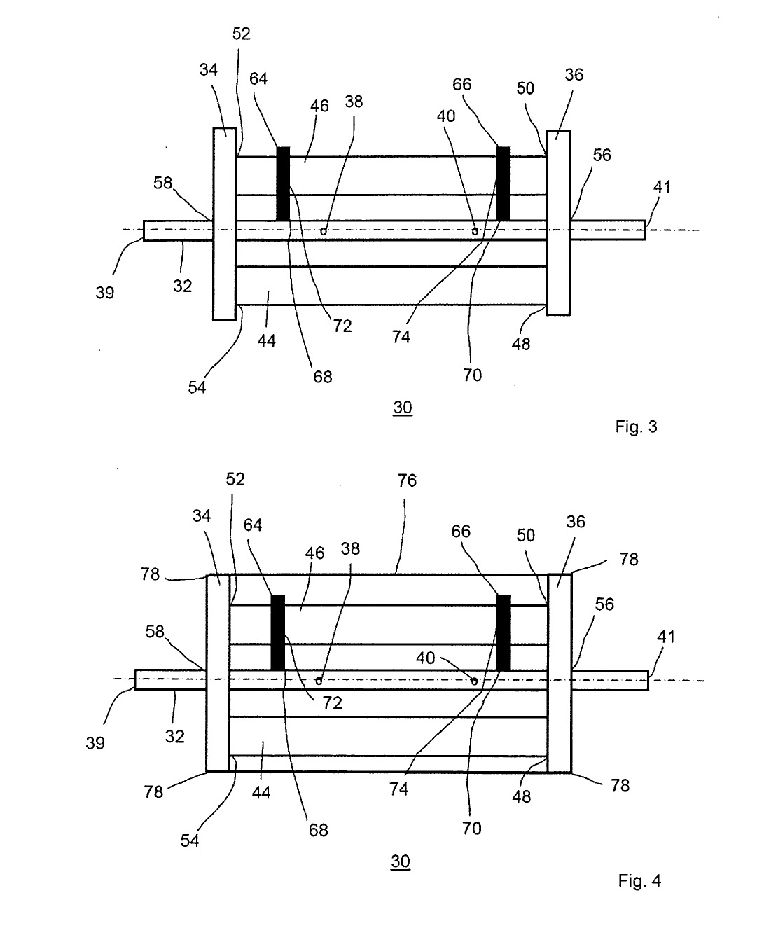

FIG. 3 will now be taken into consideration. This figure schematically illustrates a further exemplary embodiment of a Coriolis mass flowmeter 30. This exemplary embodiment corresponds in terms of its basic design and function to the Coriolis mass flowmeter in accordance with DE 102005042677A1, to which express reference is made here in this regard.

Metallic, stiff end plates 34, 36 are attached on the measurement tube 32 close to the two end regions 39, 41 of the measurement tube 32.

In the region between the two end points 39, 41, sensors 38, 40 for recording the oscillations of the measurement tube 32 are fitted on the measurement tube 32.

Two elongate connection parts 44, 46, which run essentially parallel to the measurement tube, are connected to the end plates. They run freely between the end plates 34, 36 so that they can freely oscillate in the region between the fixing points or connection points 48, 50, 52, 54.

Furthermore, two extension arm masses 64, 66 are fixed at connection points 68, 70 on the measurement tube 32. They each have a central drilled hole 72, 74, through which the connecting part 46 is passed, the clear inner diameter of the central drilled holes 72, 74 being greater than the outer diameter of the connecting part 46.

In order to explain the function and mode of operation of the individual elements of the Coriolis mass flowmeter 30 shown in FIG. 3, also in terms of its interaction, reference is made to the abovementioned document DE 10 2005 042 677 A1.

During fitting, all the attachment parts to be connected to the measurement tube 32, namely the end plates 34, 36, the connecting parts 44, 46, the sensors 38, 40, the extension arm masses 64, 66, are connected to one another in a single hard-soldering process in a vacuum furnace.

In this case, before the beginning of the hard-soldering process, the mentioned attachment parts are fixed in their desired connection position at their respective connection points with the measurement tube, denoted by the reference numerals 48, 50, 52, 54, 56, 58, 68, 70. This can take place with the aid of corresponding auxiliary or holding apparatuses or by means of point welding, screwing, adhesive bonding etc.

The structural unit which comprises structural units which are aligned with respect to one another precisely in such a way, is inserted as a whole into a vacuum soldering furnace, and all the connection points are soldered at the same time.

FIG. 4 shows the Coriolis mass flowmeter 30 shown in FIG. 3, in which a housing 76 in the form of a tube surrounding the device is still connected to the end plates 36, 37 at additional, annular connection points 78. The housing 76 is connected to the measurement tube and to the end plates 34, 36 in the same hard-soldering process together with all the other attachment parts, as shown in FIG. 3.

In this way, very efficient manufacture of a Coriolis mass flowmeter is possible. A large number of attachment parts on the measurement tube are fixedly connected in accordance with the method according to the disclosure in a single working step, and the connection takes place in such a way that thermal stresses are avoided. In all methods known until now from the prior art for producing Coriolis mass flowmeters, the individual attachment parts each need to be fixed separately, which firstly takes longer and also makes the precise geometric alignment of the attachment parts more difficult, which is absolutely necessary for precise and reliable functioning of the device. In the method according to the disclosure, on the other hand, the precise geometric alignment of all attachment parts only takes place once, and then all attachment parts which are aligned with one another are connected fixedly to the measurement tube and to one another in a single hard-soldering process.

The described method is of course not restricted in terms of its application to the variant embodiments described in the exemplary embodiments, but can be applied to all conceivable variant embodiments of Coriolis mass flowmeters.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

2 Measurement tube

4 U-shaped attachment part

6 Fixing point

7 Fixing point

9 End point of measurement tube

11 End point of measurement tube

14 First section of T/time profile

16 Zone with steeper gradient

18 First plateau

20 Second plateau

22 First cooling ramp

24 Zone of slower cooling

30 Coriolis mass flowmeter

32 Measurement tube

34 End plate

36 End plate

38 Sensor

39 End point of measurement tube

40 Sensor

41 End point of measurement tube

44 Elongate connecting part

46 Elongate connecting part

48 Fixing point

50 Fixing point

52 Fixing point

54 Fixing point

56 Connection point

58 Connection point

64 Extension arm mass

66 Extension arm mass

68 Connection point

70 Connection point

72 Central drilled hole

74 Central drilled hole

76 Housing

78 Connection point

What is claimed is:

1. Method for fixing an attachment part on the measurement tube of a Coriolis mass flowmeter at at least two connection points, wherein the measurement tube and the attachment part are soldered to one another in a single hard-soldering process at the same time at the at least two connection points.

2. Method according to claim 1, the attachment part being extended in the longitudinal direction of extent of the measurement tube, and the at least two connection points on the measurement tube being applied at the same time in a single hard-soldering process such that they are spaced apart from one another in the axial direction.

3. Method according to claim 1, the measurement tube and the attachment part to be connected thereto together are introduced into a furnace surrounding them as a whole and are heated uniformly so that, during the heating, a temperature curve is run through in only one single and cohesive temperature-regulated process for producing the soldered joints.

4. Method according to claim 3, the attachment part comprising attachment sub-parts, which are soldered to one another in the single hard-soldering process at the same time as the attachment part is soldered on the measurement tube.

5. Method for fixing a plurality of attachment parts on the measurement tube of a Coriolis mass flowmeter at a plurality of connection points, wherein the measurement tube and the attachment parts are soldered to one another in a single hard-soldering process at the same time at all connection points.

6. Method according to claim 5, the measurement tube and the attachment parts being connected thereto together being introduced into a furnace surrounding them as a whole and being heated uniformly such that, during the heating, a temperature curve is run through in only a single and cohesive temperature-regulated process for producing the soldered joints.

7. Method according to claim 1, the parts to be connected being held in their desired connection position at least at the beginning of the hard-soldering process.

8. Coriolis mass flow meter with a measurement tube and an attachment part, which is connected thereto at at least two connection points, wherein the measurement tube and the attachment part are soldered to one another in a single hard-soldering process at the same time at the at least two connection points.

9. Coriolis mass flowmeter according to claim 8, the attachment part being extended in the longitudinal direction of extent of the measurement tube, and the at least two connection points on the measurement tube being applied at the same time in a single hard-soldering process in such a way that they are spaced apart from one another in the axial direction.

10. Coriolis mass flowmeter with a measurement tube and an attachment part, which is connected thereto at at least two connection points, wherein the measurement tube and the attachment part are soldered to one another in a single hard-soldering process at the same time at the at least two connection points, which is produced in accordance with a method according to claim 3.

11. Coriolis mass flowmeter with a measurement tube and a plurality of attachment parts, which are connected to the measurement tube at a plurality of connection points, wherein the measurement tube and the attachment parts are soldered to one another in a single hard-soldering process at the same time at all connection points.

12. Coriolis mass flow meter with a measurement tube and a plurality of attachment parts, which are connected to the measurement tube at a plurality of connection points, wherein the measurement tube and the attachment parts are soldered to one another in a single hard-soldering process at the same time at all connection points, which is produced in accordance with a method according to claim 3.

13. Method according to claim 2, the parts to be connected being held in their desired connection position at least at the beginning of the hard-soldering process.

14. Method according to claim 3, the parts to be connected being held in their desired connection position at least at the beginning of the hard-soldering process.

15. Method according to claim 4, the parts to be connected being held in their desired connection position at least at the beginning of the hard-soldering process.

16. Method according to claim 5, the parts to be connected being held in their desired connection position at least at the beginning of the hard-soldering process.

17. Method according to claim 6, the parts to be connected being held in their desired connection position at least at the beginning of the hard-soldering process.
